(19) United States
(12) Patent Application Publication
(10) Pub. No.: US 2013/0222410 A1
(43) Pub. Date: Aug. 29, 2013

(54) IMAGE DISPLAY APPARATUS

(71) Applicant: KABUSHIKI KAISHA TOSHIBA, (US)

(72) Inventors: Kenichi KAMEYAMA, Tokyo (JP); Akihisa MORIYA, Kanagawa-ken (JP); Aira HOTTA, Kanagawa-ken (JP)

(73) Assignee: KABUSHIKI KAISHA TOSHIBA, Tokyo (JP)

(21) Appl. No.: 13/764,032

(22) Filed: Feb. 11, 2013

(30) Foreign Application Priority Data
Feb. 23, 2012 (JP) 2012-037502

(51) Int. Cl. G06T 19/00

(52) U.S. Cl. CPC G06T 19/006
USPC 345/589; 345/629

(57) ABSTRACT

According to one embodiment, an image display apparatus includes a data output unit, a first display device and a second display device. The data output unit is configured to output first data and second data. The first display device includes a first display unit. The second display device includes a second display unit. The data output unit is configured to implement at least one selected from a first output operation and a second output operation. The first output operation includes a first operation and a second operation. The first operation is configured to output the first data. The second operation is configured to output the second data after the first operation. The second output operation includes a third operation and a fourth operation. The third operation is configured to output the second data. The fourth operation is configured to output the first data after the third operation.

### CROSS-REFERENCE TO RELATED APPLICATIONS

This application is based upon and claims the benefit of priority from the prior Japanese Patent Application No. 2012-037502, filed on Feb. 23, 2012; the entire contents of which are incorporated herein by reference.

### FIELD

Embodiments described herein relate generally to an image display apparatus.

### BACKGROUND

Augmented reality presentation technology fuses the real world and the virtual world. In such technology, a virtual object image is superimposed onto a real-world image. Or, a real-world image is acquired using a camera; the image that is acquired is used as the virtual world; and a virtual object image is superimposed onto this image.

Harmony between the real world and virtual objects is desirable in new high-presence displays.

### BRIEF DESCRIPTION OF THE DRAWINGS

FIG. 1 is a schematic view showing an image display apparatus according to a first embodiment;

FIG. 2 is a schematic view showing a portion of the image display apparatus according to the first embodiment;

FIG. 3A and FIG. 3B are flowcharts showing an operation of the image display apparatus according to the first embodiment;

FIG. 4A to FIG. 4H are schematic views showing operations of the image display apparatus according to the first embodiment;

FIG. 5A to FIG. 5D are schematic views showing another operation of the image display apparatus according to the first embodiment;

FIG. 6A to FIG. 6D are schematic views showing another operation of the image display apparatus according to the first embodiment;

FIG. 7 is a flowchart showing another operation of the image display apparatus according to the first embodiment;

FIG. 8A to FIG. 8F are schematic views showing another operation of the image display apparatus according to the first embodiment;

FIG. 9 is a flowchart showing the operation of the image display apparatus according to the first embodiment;

FIG. 10 and FIG. 11 are schematic views showing the operation of the image display apparatus according to the first embodiment;

FIG. 12A and FIG. 12B are schematic views showing operations of the image display apparatus according to the first embodiment;

FIG. 13A to FIG. 13C are schematic views showing an operation of the image display apparatus according to the first embodiment;

FIG. 14A and FIG. 14B are schematic views showing an operation of the image display apparatus according to the first embodiment;

FIG. 15A and FIG. 15B are schematic views showing another operation of the image display apparatus according to the first embodiment;

FIG. 16A to FIG. 16E are schematic views showing an experiment relating to the characteristics of the image display apparatus;

FIG. 17 is a schematic view showing another operation of the image display apparatus according to the first embodiment;

FIG. 18 is a schematic view showing the configuration and an operation of the image display apparatus according to the first embodiment; and

FIG. 19 is a schematic view showing another image display apparatus according to the first embodiment.

### DETAILED DESCRIPTION

According to one embodiment, an image display apparatus includes a data output unit, a first display device and a second display device. The data output unit is configured to output first data and second data. The first data includes information of a first image. The second data includes information of a second image. The first display device includes a first display unit configured to display the first image based on the first data. The first display unit is optically transmissive. The second display device includes a second display unit configured to display the second image based on the second data. The second image displayed by the second display unit is viewable by a human viewer via the first display unit.

The data output unit is configured to implement at least one selected from a first output operation and a second output operation.

The first output operation includes a first operation and a second operation. The first operation is configured to output the first data including the information of the first image including a first display object. The second operation is configured to output the second data including the information of the second image including a second display object after the first operation based on the first display object. A position of the second display object in the second image is a position overlaying the first display object as viewed by the human viewer or a position on an extension of a movement of the first display object as viewed by the human viewer.

The second output operation includes a third operation and a fourth operation. The third operation is configured to output the second data including the information of the second image including a third display object. The fourth operation is configured to output the first data including the information of the first image including a fourth display object after the third operation based on the third display object. A position of the fourth display object in the first image is a position overlaying the third display object as viewed by the human viewer or a position on an extension of a movement of the third display object as viewed by the human viewer.

Various embodiments will be described hereinafter with reference to the accompanying drawings.

The drawings are schematic or conceptual; and the relationships between the thicknesses and the widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

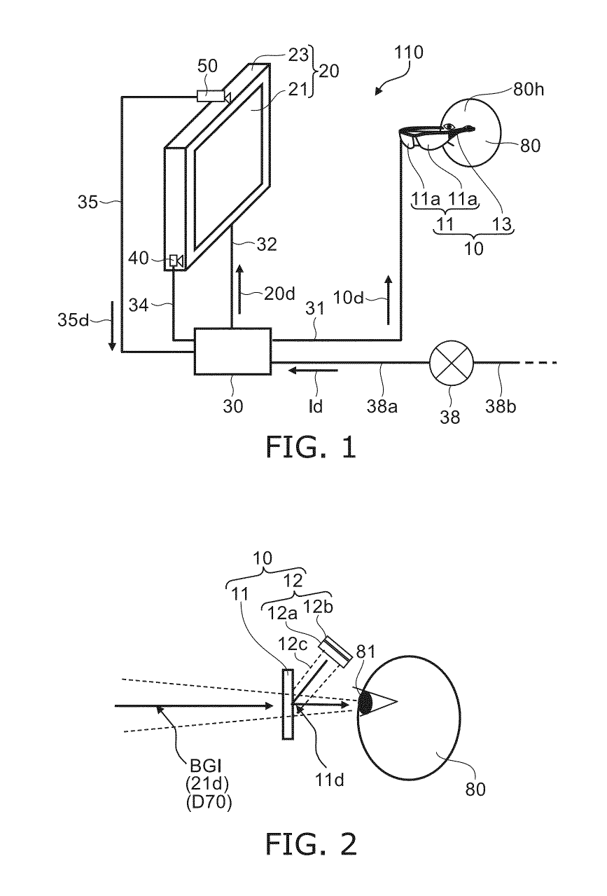

FIG. 1 is a schematic view illustrating an image display apparatus according to a first embodiment.

As illustrated in FIG. 1, the image display apparatus 110 according to the embodiment includes a data output unit 30, a first display device 10, and a second display device 20. The first display device 10 is connected to the data output unit 30 by a first communication path 31 by a wired or wireless method. The second display device 20 is connected to the data output unit 30 by a second communication path 32 by a wired or wireless method.

The data output unit 30 outputs first data 10d of a first image and second data 20d of a second image. The first data 10d is supplied to the first display device 10 from the data output unit 30. The second data 20d is supplied to the second display device 20 from the data output unit 30.

For example, the first data 10d and the second data 20d are generated by the data output unit 30. As described below, the first data 10d and the second data 20d may be generated by a portion separate from the data output unit 30. In such a case, the data output unit 30 acquires the first data 10d and the second data 20d that are generated via any communication path and outputs the first data 10d and the second data 20d that are acquired.

The first display device 10 includes a first display unit 11. The first display unit 11 displays the first image based on the first data 10d. The first display unit 11 is optically transmissive. For example, the first display device 10 is a head mounted display device (HMD) that is wearable by a human viewer 80. For example, the first display device 10 is linked to the movement of the head 80h of the user (the human viewer 80).

For example, the first display unit 11 includes a left eye display unit 11a that is arrangeable in front of the left eye of the human viewer 80, and a right eye display unit 11b that is arrangeable in front of the right eye of the human viewer 80. In addition to the first display unit 11, the first display device 10 further includes a holding unit 13 that enables the first display unit 11 to be held by the head of the human viewer 80. For example, the first display unit 11 is disposed at a position corresponding to the lenses of glasses. For example, the holding unit 13 is a portion corresponding to the temple arms of glasses. An example of the first display device 10 is described below.

The second display device 20 includes a second display unit 21. The second display unit 21 displays the second image based on the second data 20d. In this example, the second display device 20 further includes a housing 23 that contains the second display unit 21. The second image that is displayed by the second display unit 21 is viewable by the human viewer 80 via the first display unit 11. For example, the second display device 20 is not linked to the movement of the head 80h of the human viewer 80. For example, the second display device 20 is a stationary display device. Or, the second display device 20 may be a portable display device that is not linked to the movement of the head 80h of the human viewer 80.

For example, the data output unit 30 is connected to an input/output unit 38 via a wired or wireless communication path 38a. The input/output unit 38 is connected to a component outside the image display apparatus 110 via a wired or wireless communication path 38b. Image data IDImage data ID for the displays is supplied from outside the image display apparatus 110 to the data output unit 30 via the communication path 38b, the input/output unit 38, and the communication path 38a.

For example, the data output unit 30 generates the first data 10d and the second data 20d based on the Image data IDImage data ID. Then, the data output unit 30 outputs the first data 10d and the second data 20d that are generated.

In this example, the image display apparatus 110 further includes a first sensor 50. The first sensor 50 detects the relative position and the relative angle between the first display device 10 and the second display device 20. The first sensor 50 may include, for example, an imaging device (a camera, etc.), a combination of an electromagnetic wave emitting unit and an electromagnetic wave detection unit, a combination of a sound wave emitting unit and a sound wave detection unit, etc.

The first sensor 50 is connected to the data output unit 30 by a wired or wireless first sensor communication path 35. Position/orientation data 35d relating to the relative position and the relative angle between the first display device 10 and the second display device 20 that are detected by the first sensor 50 is supplied to the data output unit 30 by way of the first sensor communication path 35.

In this example, the image display apparatus 110 further includes a sound producing unit 40. The sound producing unit 40 may include, for example, a speaker, etc. The sound producing unit 40 is connected to the data output unit 30 via a wired or wireless sound producing unit communication path 34. The sound producing unit 40 produces sound in an operation (at least one operation selected from the first output operation and the second output operation described below) of the data output unit 30. The sound producing unit 40 may be additionally provided in the first display device 10. The sound producing unit 40 may be additionally provided in the second display device 20.

The second display device 20 may include, for example, a liquid crystal display device, an organic electroluminescence display device, a plasma display device, a projection display device (e.g., a projector), etc. The first sensor 50 may include, for example, an imaging device and an electronic device that performs image analysis of the image that is imaged by the imaging device. The data output unit 30 may include a computer. For example, the computer may include a display controller. The computer is connectable to a network. The computer may include a communication terminal that is connectable to a computer in the cloud.

FIG. 2 is a schematic view illustrating a portion of the image display apparatus according to the first embodiment.

As illustrated in FIG. 2, the first display device 10 may further include an image generation unit 12 in addition to the first display unit 11. In this example, a semi-transmissive reflection plate (a semi-transmissive reflective layer) is used as the first display unit 11. For example, the image generation unit 12 includes a light source 12b and a display device 12a. The display device 12a may include, for example, a liquid crystal display device (an optical switch)), etc. The light emitted from the light source 12b is modulated by the display device 12a to generate a first image 11d. The image generation unit 12 may include, for example, a self-emitting display device such as an organic electroluminescence display device, etc. In such a case, the light source 12b may be omitted. Light 12c including the first image 11d generated by the image generation unit 12 is incident on the first display unit 11. The light 12c is incident on an eye 81 of the human viewer 80 by being reflected by the first display unit 11. The human viewer 80 views the first image 11d (e.g., a virtual image) that is formed of the light 12c.

In the embodiment, the configuration of the first display device 10 is arbitrary; and, for example, the first display unit 11 may generate the first image 11d.

Because the first display unit 11 is optically transmissive, it is possible for the human viewer 80 to view an image of the background (a background image BGI) via the first display unit 11. For example, the background image BGI is a second image 21d that is displayed by the second display unit 21 of the second display device 20. Or, for example, the background image BGI is an image of an object (an object image D70) existing in a region around the first display device 10 (around the human viewer 80). For example, the object image D70 may be a virtual image formed by a mirror, etc. The object image D70 may be an image of an object existing in the region around the first display device 10 (around the human viewer 80). The object image D70 may be the image of at least a portion of the body of the human viewer 80 that exists in the region around the first display device 10.

The first image 11d displayed by the first display unit 11 may be viewed by the human viewer 80 as being superimposed onto the background image BGI (e.g., at least one selected from the second image 21d and the object image D70) which is viewed via the first display unit 11.

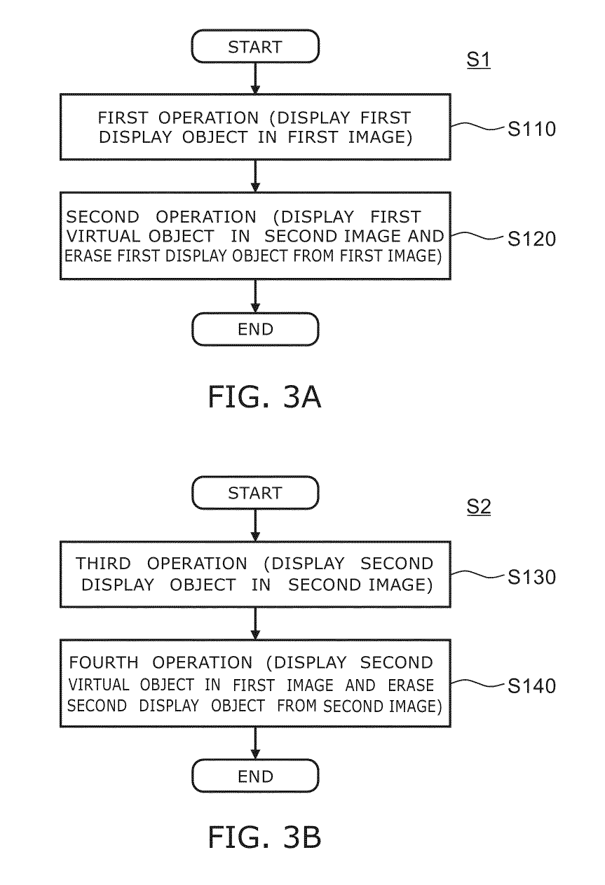

FIG. 3A and FIG. 3B are flowcharts illustrating an operation of the image display apparatus according to the first embodiment.

These drawings also illustrate a display method according to a second embodiment described below.

The data output unit 30 implements at least one selected from a first output operation S1 illustrated in FIG. 3A and a second output operation S2 illustrated in FIG. 3B.

As illustrated in FIG. 3A, the first output operation S1 includes a first operation S110 and a second operation S120. As illustrated in FIG. 3B, the second output operation S2 includes a third operation S130 and a fourth operation S140.

In the first operation S110, the data output unit 30 outputs the first data 10d to display a first display object in the first image 11d. The first data 10d that is output is supplied to the first display device 10.

The data output unit 30 implements the second operation S120 after the first operation S110. In the second operation S120, the data output unit 30 outputs the second data 20d to display a display object (a second display object) in the second image 21d based on the first display object at a position overlaying the first display object as viewed by the human viewer 80 or at a position on an extension of the movement of the first display object as viewed by the human viewer 80. The second data 20d that is output is supplied to the second display device 20.

In the third operation S130, the data output unit 30 outputs the second data 20d to display a third display object in the second image 21d. The second data 20d that is output is supplied to the second display device 20.

The data output unit 30 implements the fourth operation S140 after the third operation S130. In the fourth operation S140, the data output unit 30 outputs the first data 10d to display a display object (a fourth display object) in the first image 11d based on the third display object at a position overlaying the third display object as viewed by the human viewer 80 or at a position on an extension of the movement of the third display object as viewed by the human viewer 80. The first data 10d that is output is supplied to the first display device 10.

First, an example of the second output operation S2 will be described.

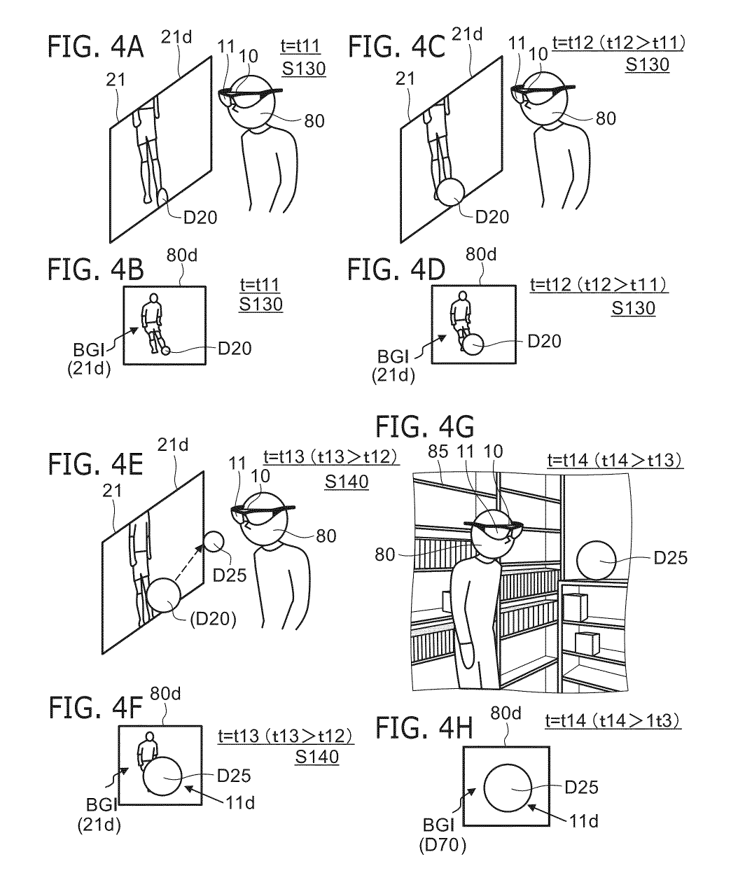

FIG. 4A to FIG. 4H are schematic views illustrating operations of the image display apparatus according to the first embodiment.

These drawings illustrate an example of the second output operation S2. These drawings illustrate the application example in which the human viewer 80 views circumstances from real space, and a designated display object of an image of a movie, television, etc., jumps out from the virtual space. In this example, an image of a sport is displayed as the second image 21d by the second display unit 21 of the second display device 20. In the second image 21d, the image of a ball used in the sport may be used as the designated display object.

FIG. 4A and FIG. 4B illustrate the state in which a time t is a first time t11. FIG. 4C and FIG. 4D illustrate the state in which the time t is a second time t12. The second time t12 is a time after the first time t11. FIG. 4E and FIG. 4F illustrate the state in which the time t is a third time t13. The third time t13 is a time after the second time t12. FIG. 4G and FIG. 4H illustrate the state in which the time t is a fourth time t14. The fourth time t14 is a time after the third time t13. FIG. 4A, FIG. 4C, and FIG. 4E illustrate the relationship between the dispositions of the human viewer 80 and the second display unit 21. FIG. 4G illustrates the state of the human viewer 80. FIG. 4B, FIG. 4D, FIG. 4F, and FIG. 4H illustrate a viewed image 80d (the first image 11d and the background image BGI) that the human viewer 80 views via the first display unit 11.

For example, at the first time t11 as illustrated in FIG. 4A, the human viewer 80 views the second display unit 21 of the second display device 20 via the first display unit 11. The second image 21d is displayed by the second display unit 21. In the second image 21d, the image of the ball used in the sport may be used as a third display object D20.

This operation is performed by the data output unit 30. In other words, the data output unit 30 outputs the second data 20d to display the third display object D20 in the second image 21d (the third operation S130).

At this time, an image relating to the third display object D20 (the ball) is not displayed by the first display unit 11. As illustrated in FIG. 4B, the human viewer 80 perceives the second image 21d (including the third display object D20) as the viewed image 80d. The viewed image 80d includes the second image 21d that is displayed by the second display unit 21 as the background image BGI.

At the second time t12 as illustrated in FIG. 4C, the ball (the third display object D20) moves toward the human viewer 80. For example, the size of the ball (the third display object D20) in the second image 21d becomes greater than the size at the first time t11.

As illustrated in FIG. 4D, an image relating to the third display object D20 (the ball) is not displayed by the first display unit 11. The human viewer 80 perceives the second image 21d (including the third display object D20) as the viewed image 80d.

At the third time t13 as illustrated in FIG. 4E, the ball (the third display object D20) moves further toward the human viewer 80. At this time, a display object (a fourth display object D25) based on the third display object D20 is displayed in the first image 11d. The position of the fourth display object D25 in the first image 11d is a position in the first image 11d overlaying the third display object D20 as viewed by the human viewer 80 or a position in the first image 11d on an extension of the movement of the third display object D20 as viewed by the human viewer 80. The configuration and the color of the fourth display object D25 are set to be substantially the same as the configuration and the color of the third display object D20 of the second image 21d of the second display unit 21 as viewed by the human viewer 80.

This operation is performed by the data output unit 30. In other words, the data output unit 30 outputs the first data 10d to display the display object (the fourth display object D25) in the first image 11d based on the third display object at a position overlaying the third display object D20 as viewed by the human viewer 80 or at a position on an extension of the movement of the third display object D20 as viewed by the human viewer 80 (the fourth operation S140).

Thereby, as illustrated in FIG. 4F, the fourth display object D25 (the ball) is displayed by the first display unit 11. The human viewer 80 perceives the fourth display object D25 in the first image 11d as the viewed image 80d. The viewed image 80d includes the second image 21d that is displayed by the second display unit 21 as the background image BGI. The human viewer 80 perceives both the second image 21d and the fourth display object D25. Thereby, for example, the human viewer 80 perceives the fourth display object D25 (the ball) to have jumped out frontward from the second display unit 21.

At the fourth time t14 as illustrated in FIG. 4G, the human viewer 80 views a direction that is different from the direction toward the second display unit 21. The human viewer 80 views the fourth display object D25 in the first image 11d displayed by the first display unit 11.

As illustrated in FIG. 4H, the human viewer 80 perceives the fourth display object D25 in the first image 11d as the viewed image 80d. At this time, an object (e.g., an interior wall, etc.) that exists in the region around the human viewer 80 exists in the background of the viewed image 80d. The human viewer 80 perceives both the fourth display object D25 and the object image D70 that exists in the region around the first display device 10 (around the human viewer 80). Thereby, the human viewer 80 perceives that the fourth display object D25 (the ball) has jumped out from the second display unit 21 toward the region around the human viewer 80 in real space.

For example, in the case where the first display device 10 is not used and only the second display device 20 is used as the image display apparatus, the human viewer 80 perceives the display state illustrated in FIG. 4A to FIG. 4D. For example, although it appears as if the ball has moved from far away to a proximity as viewed by the human viewer 80 when the size of the third display object D20 (the ball) that is displayed by the second display unit 21 changes, the ball does not appear to jump out frontward from the second display unit 21. For example, in the case where the third display object D20 moves in the second image 21d and goes outside the frame of the second image 21d (the frame of the second display unit 21), the third display object D20 moves outside the frame and vanishes from the image.

Conversely, in the image display apparatus 110 according to the embodiment, the first display device 10 is used to display the fourth display object D25 (the ball) based on the third display object D20 in the first image 11d of the first display unit 11. Thereby, as described in regard to FIG. 4E and FIG. 4F, the human viewer 80 perceives the ball (the third display object D20, i.e., the fourth display object D25) to jump out seamlessly from the virtual space into real space. Further, the human viewer 80 can view the image (the ball) even when the orientation of the human viewer 80 is changed (FIG. 4G) from the direction toward the second display unit 21 to the direction in which the ball flies. According to the image display apparatus 110, a surprising image can be provided to the human viewer 80.

For example, in a powerful scene, an image of a portion (in this example, the ball, i.e., the fourth display object D25) is displayed in the first image 11d to move the image from the second image 21d into the first image 11d. Then, the ball (the fourth display object D25) that jumped out from the second display unit 21 is perceived to be superimposed onto real space. Thereby, the ball is perceived to exist inside real space.

According to the image display apparatus 110 according to the embodiment, the virtual object can be moved seamlessly between the virtual space and real space. Thereby, an image display apparatus having a strong sense of presence and better harmony between real space and the virtual object can be provided.

In the fourth operation S140, the display object (the fourth display object D25) based on the third display object D20 is displayed in the first image 11d. In the fourth operation S140, the third display object D20 may be erased from the second image 21d. Or, in the fourth operation S140, the contrast of the third display object D20 may be lower than that in the previous state (e.g., the state of the third operation S130). Thereby, the third display object D20 is difficult to view in the second image 21d.

For example, in the fourth operation S140, the third display object D20 is substantially erased from the second image 21d; and the fourth display object D25 based on the third display object D20 is displayed in the first image 11d. Thereby, the third display object D20 is perceived to move more naturally from the second image 21d into the first image 11d. Thereby, the harmony between real space and the virtual object can be even better; and the sense of presence can be even stronger.

Thus, in the fourth operation S140, the data output unit 30 may further implement outputting the second data 20d to erase the third display object D20 from the second image 21d. In other words, the data output unit 30 may further implement outputting the second data 20d in the fourth operation S140 to include the information of the second image 21d not including the third display object D20. The data output unit 30 may further implement outputting the second data 20d including the information of the second image 21d such that the ratio of the luminance of the third display object D20 to the luminance around the third display object D20 in the second image 21d of the fourth operation S140 is lower than the ratio of the luminance of the third display object D20 to the luminance around the third display object D20 of the third operation S130.

In this example, the fourth operation S140 is implemented according to the movement of the third display object D20 in the second image 21d in the third operation S130. In other words, the fourth operation S140 is started using the movement of the third display object D20 as a trigger. For example, the fourth operation S140 is implemented when the third display object D20 is displayed to move from the depthward portion of the second image 21d toward the front as viewed by the human viewer 80 in the third operation S130. For example, the fourth operation S140 is not implemented when the third display object D20 is displayed to move from the front toward the depthward portion of the second image 21d as viewed by the human viewer 80 in the third operation S130. Thus, when the third display object D20 is displayed in a designated state, the fourth operation S140 is implemented; and the fourth display object D25 is displayed such that the third display object D20 appears to move from the second image 21d into the first image 11d. Thereby, an even stronger sense of presence can be provided to the human viewer 80.

For example, the data output unit 30 implements the fourth operation S140 when the movement of the third display object D20 in the second image 21d in the third operation S130 meets a predetermined condition. For example, the predetermined condition may include the state in which the size of the third display object D20 increases over time. The predetermined condition may include the state in which the size of the third display object D20 changes continuously over time. Thereby, for example, as viewed by the human viewer 80, the third display object D20 appears to have moved from the second image 21d into the first image 11d in the case of the state in which the third display object D20 is perceived to move toward the human viewer 80.

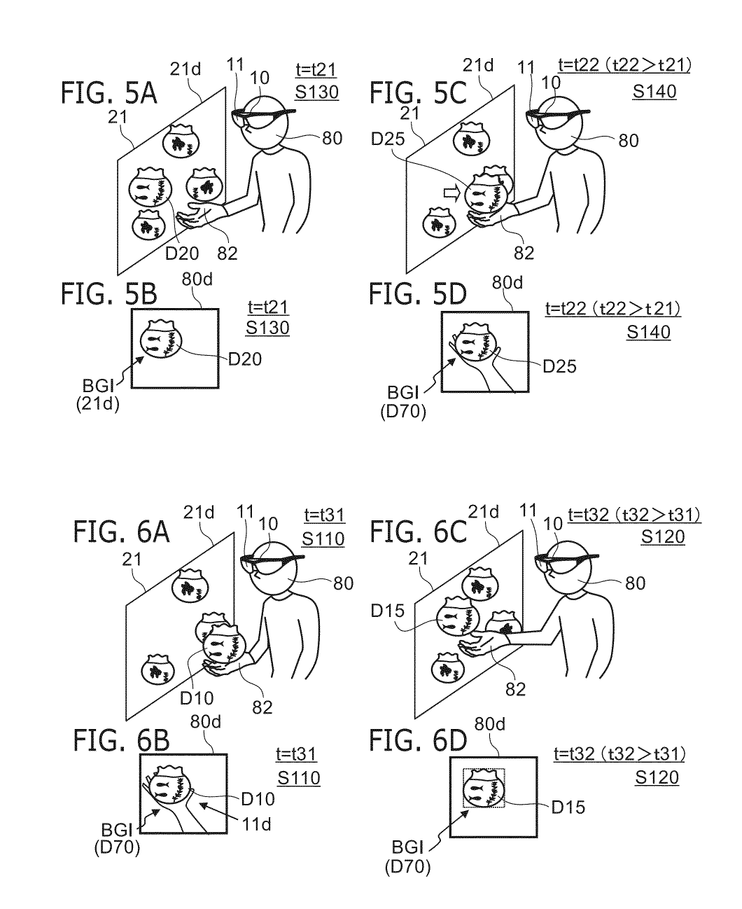

FIG. 5A to FIG. 5D are schematic views illustrating another operation of the image display apparatus according to the first embodiment.

These drawings illustrate another example of the second output operation S2. These drawings are an example in which the second display device 20 is used as digital signage. For example, the second display device 20 is mounted in a public location. In this example, an image including several pieces of merchandise is displayed as the second image 21d by the second display unit 21 of the second display device 20. The images of the merchandise displayed in the second image 21d may be used as the third display object D20.

FIG. 5A and FIG. 5B illustrate the state in which the time t is a first time t21. FIG. 5C and FIG. 5D illustrate the state in which the time t is a second time t22. The second time t22 is a time after the first time t21. FIG. 5A and FIG. 5C illustrate the relationship between the dispositions of the human viewer 80 and the second display unit 21. FIG. 5B and FIG. 5D illustrate the viewed image 80d (the first image 11d and the background image BGI) that is viewed by the human viewer 80 via the first display unit 11.

For example, at the first time t21 as illustrated in FIG. 5A, the human viewer 80 views the second display unit 21 of the second display device 20 via the first display unit 11. The second image 21d is displayed by the second display unit 21. The third display object D20 which is the image of the merchandise is displayed in the second image 21d (the third operation S130).

At this time, as illustrated in FIG. 5B, the human viewer 80 perceives the second image 21d (including the third display object D20) as the viewed image 80d. The second image 21d that is displayed by the second display unit 21 is included in the viewed image 80d as the background image BGI.

In this state, the human viewer 80 causes a hand (the body 82) of the human viewer 80 to approach the second display unit 21. Thereby, the data output unit 30 implements the fourth operation S140 recited below.

At the second time t22 as illustrated in FIG. 5C, the image (the fourth display object D25) that is based on the image (the third display object D20) of the merchandise is displayed in the first image 11d (the fourth operation S140). For example, as viewed by the human viewer 80, the position of the fourth display object D25 in the first image 11d is a position in the first image 11d overlaying the third display object D20. As viewed by the human viewer 80, the configuration and the color of the fourth display object D25 are set to be substantially the same as the configuration and the color of the third display object D20 of the second image 21d of the second display unit 21.

In this example, a state is formed in which the user (the human viewer 80) grasps and views the virtual object (the merchandise) displayed by the second display unit 21 that displays the digital signage. According to the embodiment, an image display apparatus having a strong sense of presence and better harmony between real space and the virtual object can be provided.

In such a case as well, in the fourth operation S140, the third display object D20 is erased from the second image 21d, or the contrast of the third display object D20 is caused to be lower than that in the state of the third operation S130. Thereby, the sense of presence is even stronger.

In this example, the fourth operation S140 is implemented when the human viewer 80 moves the hand (the body 82). Thus, the image display apparatus 110 can be operated by the human viewer 80 moving the body 82 (any portion such as a hand, a leg, the torso, the head, etc.) of the human viewer 80. Thus, the operation by the human viewer 80 includes moving the body 82 of the human viewer 80. In this example, the data output unit 30 implements the fourth operation S140 based on the operation by the human viewer 80. Thereby, the human viewer 80 can bring the third display object D20 (e.g., the image of the merchandise) corresponding to the intention of the human viewer 80 into the first image 11d from the second image 21d. For example, the data of the image may be stored in any memory portion as the data of the fourth display object D25. The data that is stored may be extracted and displayed by any display device at any time.

An example of the first output operation S1 will now be described.

FIG. 6A to FIG. 6D are schematic views illustrating another operation of the image display apparatus according to the first embodiment.

These drawings illustrate an example of the first output operation S1. FIG. 6A and FIG. 6B illustrate the state in which the time t is a first time t31. FIG. 6C and FIG. 6D illustrate the state in which the time t is a second time t32. The second time t32 is a time after the first time t31. FIG. 6A and FIG. 6C illustrate the relationship between the dispositions of the human viewer 80 and the second display unit 21. FIG. 6B and FIG. 6D illustrate the viewed image 80d (the first image 11d and the background image BGI) that is viewed by the human viewer 80 via the first display unit 11.

For example, at the first time t31 as illustrated in FIG. 6A and FIG. 6B, a first display object D10 is displayed in the first image 11d (the first operation S110). For example, the first display object D10 is displayed such that the first display object D10 is placed on the hand (the body 82) of the human viewer 80 as viewed by the human viewer 80. The first display object D10 is any display pattern, e.g., the image of a work of art.

For example, at the second time t32 after the first operation S110 as illustrated in FIG. 6C and FIG. 6D, the human viewer 80 moves the hand (the body 82) toward the second display unit 21. Thereby, the image (a second display object D15) based on the first display object D10 is displayed in the second image 21d of the second display unit 21 (the second operation S120). For example, the position of the second display object D15 in the second image 21d is a position overlaying the first display object D10 as viewed by the human viewer 80. Or, the position of the second display object D15 in the second image 21d is a position on an extension of the movement of the first display object D10 as viewed by the human viewer 80.

For example, the second display object D15 based on the first display object D10 which is the image of the work of art is displayed by the second image 21d that displays the image of the home of the human viewer 80. Thereby, the human viewer 80 can perceive the image of the work of art when placed in the home as the virtual space.

For example, the configuration and the color of the second display object D15 are set to be substantially the same as the configuration and the color of the first display object D10 of the first image 11d of the first display unit 11 as viewed by the human viewer 80.

The human viewer 80 can perceive that the first display object D10 of the first image 11d has been moved from the first image 11d into the second image 21d by the human viewer 80 viewing the second display object D15 displayed in the second image 21d.

In such a case, the data output unit 30 may further implement outputting the first data 10d to erase the first display object D10 from the first image 11d in the second operation S120. In other words, the data output unit 30 may further implement outputting the first data 10d including the information of the first image 11d not including the first display object D10 in the second operation S120. Also, the data output unit 30 may further implement outputting the first data 10d including the information of the first image 11d such that the ratio of the luminance of the first display object D10 to the luminance around the first display object D10 in the first image 11d of the second operation S120 is lower than the ratio of the luminance of the first display object D10 to the luminance around the first display object D10 of the first operation S110. In other words, the contrast of the first display object D10 in the second operation S120 is caused to be lower than that in the previous state (e.g., the state of the first operation S110). Thereby, the human viewer 80 perceives the first display object D10 as being substantially erased in the second operation S120. Thereby, the harmony between real space and the virtual object can be even better; and the sense of presence can be even stronger.

In this example, the second operation S120 is started by, for example, the human viewer 80 moving the hand (the body 82) toward the second display unit 21. In other words, the data output unit 30 implements the second operation S120 based on the operation by the human viewer 80.

The data output unit 30 may implement the second operation S120 when the movement of the first display object D10 in the first image 11d of the first operation S110 meets a predetermined condition. The predetermined condition includes, for example, a state in which a change of the first display object D10 exceeds a predetermined threshold value. For example, in the case where an image is displayed in which the form of an animal that is growing is drawn as the first display object D10, the image of the animal may be shown to jump into the second image 21d when the animal grows to a constant state. For example, the pupa of a butterfly may be displayed in the first image 11d; and when the adult butterfly emerges from the pupa, the butterfly may be moved into the second image 21d.

In the first operation S110 described in regard to FIG. 6A and FIG. 6B, the data output unit 30 may output the first data 10d including the information of the first image 11d to display the first display object D10 in the first image 11d using a reference, where the reference is the position of the object image D70 when the human viewer 80 views the object image D70 via the first display unit 11. In other words, for example, the first display object D10 is displayed such that the first display object D10 is placed on the hand (the body 82) of the human viewer 80 as viewed by the human viewer 80. Thereby, the harmony between real space and the virtual object can be even better; and the sense of presence is even stronger.

In the first operation S110, the position of the object image D70 when the human viewer 80 views the object image D70 (the hand, etc.) via the first display unit 11 is determined by, for example, the second sensor described below, etc.

The first output operation S1 and the second output operation S2 recited above may be performed simultaneously. The second output operation S2 may be implemented after the first output operation S1. The first output operation S1 may be implemented after the second output operation S2. The first output operation S1 may be implemented repeatedly. The second output operation S2 may be implemented repeatedly.

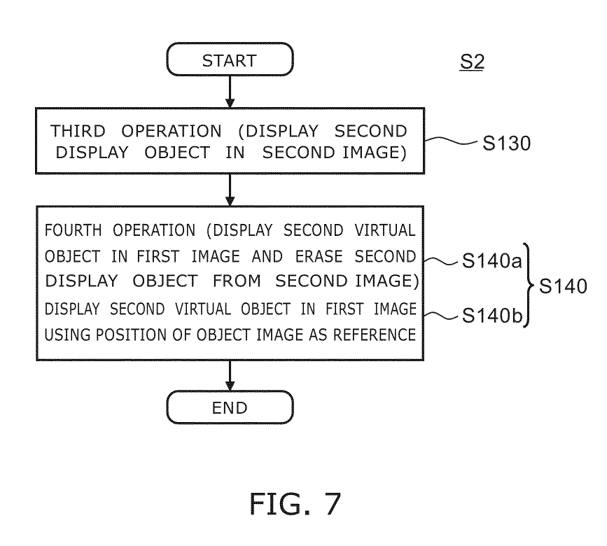

FIG. 7 is a flowchart illustrating another operation of the image display apparatus according to the first embodiment.

FIG. 7 also illustrates the display method according to the second embodiment described below.

As illustrated in FIG. 7, the data output unit 30 implements a fourth display object display operation S140a and a placement operation S140b of the fourth operation S140 of the second output operation S2.

In the fourth display object display operation S140a, the fourth display object D25 is displayed in the first image 11d. At this time, as viewed by the human viewer 80, the position of the fourth display object D25 in the first image 11d is a position overlaying the third display object D20 or a position on an extension of the movement of the third display object D20.

In the placement operation S140b, the fourth display object D25 is disposed at a prescribed position in the first image 11d. For example, the placement operation S140b is implemented after the fourth display object display operation S140a. Or, as described below, for example, the placement operation S140b is implemented simultaneously with the fourth display object display operation S140a. In the placement operation S140b, the data output unit 30 outputs the first data 10d including the information of the first image 11d to display the fourth display object D25 in the first image 11d using a reference, where the reference is the position of the object image D70 when the human viewer 80 views the object image D70 via the first display unit 11.

An example of the placement operation S140b will now be described. In the following example, the placement operation S140b is implemented after the fourth display object D25 is displayed once (after the fourth display object display operation S140a).

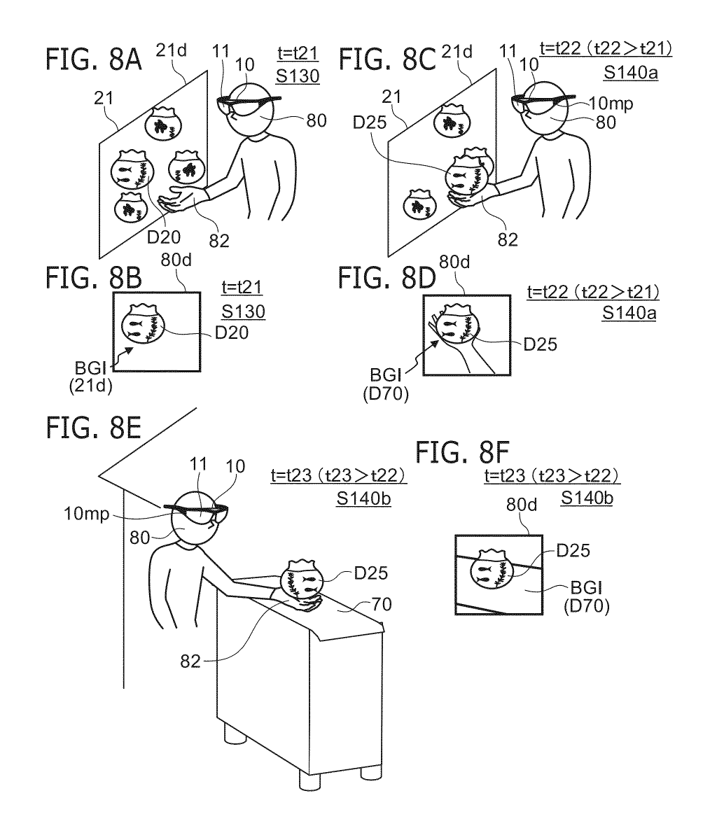

FIG. 8A to FIG. 8F are schematic views illustrating another operation of the image display apparatus according to the first embodiment.

FIG. 8A to FIG. 8D are similar to FIG. 5A to FIG. 5D, respectively. FIG. 8E and FIG. 8F illustrate the state in which the time t is a third time t23. The third time t23 is a time after the second time t22. FIG. 8E illustrates circumstances around the human viewer 80. FIG. 8F illustrates the viewed image 80d (the first image 11d and the background image BGI) that is viewed by the human viewer 80 via the first display unit 11.

For example, at the first time t21 as illustrated in FIG. 8A, the third display object D20 is displayed in the second image 21d of the second display unit 21 (the third operation S130). For example, the second image 21d is an image of digital signage. The third display object D20 is an image of merchandise.

As illustrated in FIG. 8C, the human viewer 80 causes the hand (the body 82) to approach the preferred merchandise of the digital signage. The fourth display object D25 based on the third display object D20 of the merchandise is displayed by the first display unit 11. Thereby, the image of the merchandise moves from the digital signage into the first display device 10 of the human viewer 80 (the fourth display object display operation S140a of the fourth operation S140).

At this time, for example, the digital signage may record ID data additionally provided to the image that is moved, the time at which the image is moved, ID data additionally provided to the first display device 10 to which the image is moved, etc. By recording such data, data relating to customers (the human viewers 80) having a high likelihood of purchasing the merchandise can be acquired.

For example, data relating to the fourth display object D25 displayed by the first display unit 11 may be stored in a memory portion 10 mp provided in the first display device 10. Or, this data may be stored in any memory device connected to the first display device 10 by transferring this data to the memory device.

As illustrated in FIG. 8E, the human viewer 80 may cause the first display unit 11 to display the fourth display object D25 in the home of the human viewer 80 based on the data that is stored (the placement operation S140b). At this time, an object 70 such as a desk, etc., exists in the region around the human viewer 80. The human viewer 80 views the image (the object image D70) of the object 70 via the first display unit 11. The fourth display object D25 is displayed in the first image 11d using a reference, where the reference is the position of the object image D70 when the human viewer 80 views the object image D70 via the first display unit 11.

For example, in the case where the object 70 is a desk as illustrated in FIG. 8F, the fourth display object D25 is displayed to be disposed on the desk (the object 70) as viewed by the human viewer 80. The human viewer 80 can view the fourth display object D25 in a state that is closer to reality by viewing the fourth display object D25 superimposed onto the object image D70.

If the human viewer 80 likes the merchandise (the object corresponding to the image of the fourth display object D25), purchasing procedures are performed. Then, the merchandise is delivered to the home.

In this example, it is possible for the user to take the virtual object (the fourth display object D25) of the second image 21d of the digital signage by extending user's hand and moving the virtual object to another position. For example, the user may virtually take the merchandise home from a street corner display and virtually view the merchandise superimposed onto furniture, etc., of the home. If the merchandise is liked, it is possible to procure the merchandise and subsequently receive the merchandise.

Thus, according to the image display apparatus 110 according to the embodiment, an image display apparatus having a strong sense of presence and better harmony between real space and the virtual object can be provided. According to the embodiment, for example, a display is possible in which the user can seamlessly take a virtual object from three-dimensional virtual space into real space. Then, the virtual object can be moved with the movement of the user. Also, a display is provided in which the user can seamlessly bring a virtual object that is superimposed onto real space into the virtual space.

An example of augmented reality presentation technology includes technology that superimposes a virtual object onto real space. Also, there is technology that acquires real space using a camera, uses the image that is acquired by the camera as the virtual space, and superimposes the desired virtual object onto the virtual space. In these technologies, the virtual object is not perceived to move between real space and the virtual space.

On the other hand, in a DFD (Depth-fused 3D Display) that displays two-dimensional images on multiple light-transmitting two-dimensional displays and overlays the displays, a stereoscopic image is localized in the space between the displays. In this technology as well, the virtual object is not perceived to move between real space and the virtual space.

Also, for example, there is technology that acquires a real object using a camera and links the real object to other information in a virtual space projected by a fixed projector. Also, there is an application in which the user moves a virtual object to another display terminal, etc., by hand. However, the movement of the virtual object is a movement from the image space of a projector to a display terminal; and the virtual object is not superimposed onto an object in real space.

Further, for example, there is a multiwindow function of a computer that is used as an interface to move a display object between multiple displays. In the multiwindow function, the virtual object moves from one screen to another screen. In the multiwindow function, the movement of the virtual object in the virtual space is performed inside the screens. Therefore, the virtual object is not perceived to move between the virtual space and real space.

Conversely, in the image display apparatus 110 according to the embodiment, a display device is used as the first display device 10 such that movement that matches the user is possible, and superimposition onto real space and the virtual space is possible. For example, a transmission-type HMD is used as the first display device 10. Such a first display device 10 is used in combination with the second display device 20; and the second display unit 21 of the second display device 20 is viewed via the display unit 11 of the first display device 10. Thereby, an image effect in which the virtual object jumps out from the virtual space into real space can be provided. Further, in the embodiment, an effect can be provided in which the virtual object displayed by the first display device 10 moves from real space into the virtual space (into the second image 21d).

Thus, in the image display apparatus 110 according to the embodiment, the virtual object can be perceived to move seamlessly between real space and the virtual space.

To display a virtual stationary display, it may be considered to use a configuration in which an immersive display such as a super wide view video see-through HMD, a Cave automatic virtual environment (CAVE), etc., is combined with an imaging device that obtains images of real space. In such a case, practical use is difficult because a massive device is necessary and a large mounting space is necessary.

In the embodiment, for example, the second display object D15 of the second operation S120 and the fourth display object D25 of the fourth operation S140 are generated based on the relative position and the relative angle between the first display device 10 and the second display device 20 that are detected by the first sensor 50. For example, the second display object D15 is generated such that the second display object D15 is perceived to be continuous with the first display object D10 of the first image 11d. For example, the fourth display object D25 is generated such that the fourth display object D25 is perceived to be continuous with the third display object D20 of the second image 21d. Thereby, the virtual object can be perceived to move between the first image 11d and the second image 21d.

At least one selected from the second operation S120 and the fourth operation S140 is implemented based on at least one selected from the movement of the virtual object and the prescribed operation by the user. Thereby, there can be less incongruity of the movement of the virtual object between the first image 11d and the second image 21d.

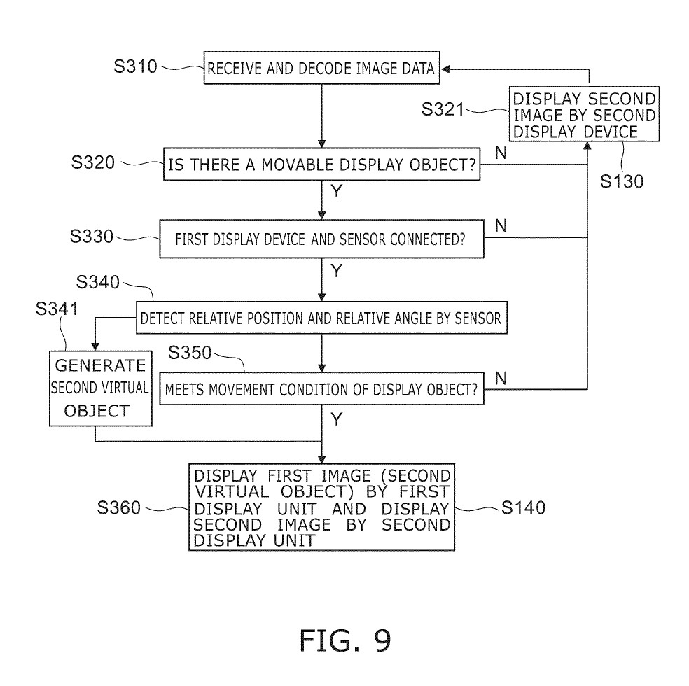

FIG. 9 is a flowchart illustrating the operation of the image display apparatus according to the first embodiment.

FIG. 9 illustrates an example of the second output operation S2.

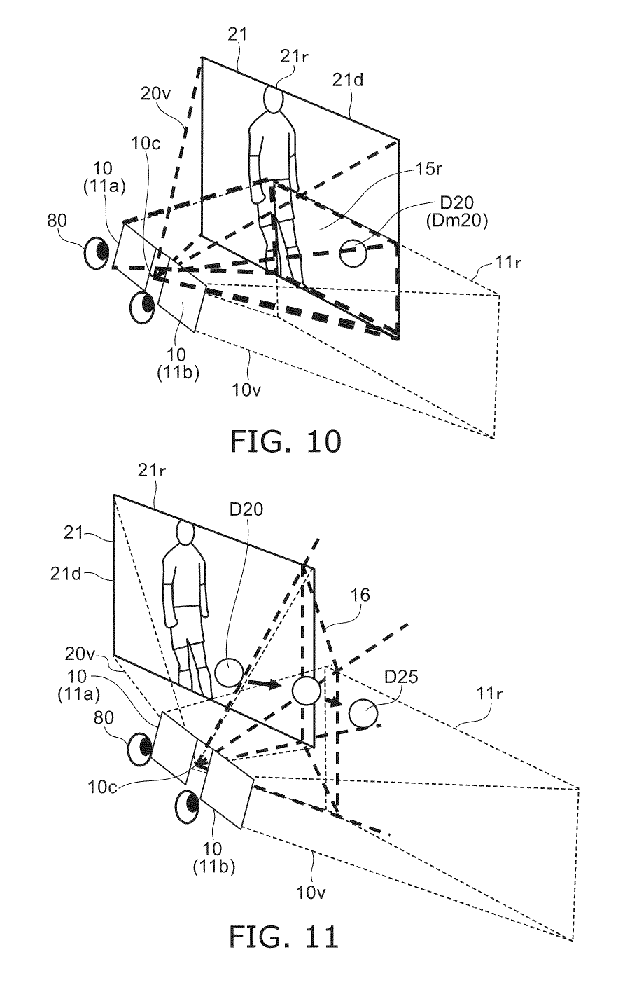

FIG. 10 and FIG. 11 are schematic views illustrating the operation of the image display apparatus according to the first embodiment.

In the data output unit 30 as illustrated in FIG. 9, the Image data IDImage data ID is received; and the Image data IDImage data ID that is received is decoded (step S310). In the data output unit 30, it is determined whether or not the image that is decoded is a scene that includes a movable image (step S320). In the case where there is no movable image, the image is displayed as-is by the second display device 20 (step S321). For example, step S321 corresponds to the third operation S130.

In the case where there is a movable image, it is determined whether or not the first display device 10 is connected to the data output unit 30 (step S330). At this time, it may be determined further whether or not the first sensor 50 is connected to the data output unit 30. For example, the peripheral devices connected to the data output unit 30 are automatically recognized by an operating system applied to the data output unit 30. In the case where peripheral devices are not connected, the image is displayed as-is by the second display device 20 (step S321).

In the case where a peripheral device is connected, a recognition flag is set that the display object is movable between the first display device 10 and the second display device 20.

Then, the first sensor 50 detects the relative position and the relative angle between the first display device 10 and the second display device 20; and the data output unit 30 acquires the information relating to the relative position and the relative angle (step S340). For example, the data output unit 30 generates the fourth display object D25 displayed by the first display unit 11 based on this information (step S341). The position and the size of the fourth display object D25 of the first display unit 11 are determined according to the relative position and the relative angle between the first display device 10 and the second display device 20.

Continuing, in the data output unit 30, it is determined whether or not the movement condition of the image of the virtual object between the first display device 10 and the second display device 20 satisfies the predetermined condition based on the information relating to the relative position and the relative angle (step S350).

As illustrated in FIG. 10, a region exists where a first viewed volume 10v of the first display device 10 and a second viewed volume 20v of the second display device 20 overlay each other. For example, when the human viewer 80 views the second display unit 21 via the first display unit 11, a region 15r exists where a display region 11r of the first display unit 11 and a display region 21r of the second display unit 21 overlay each other. For example, the overlaying region 15r corresponds to the region where the first viewed volume 10v and the second viewed volume 20v overlay each other as viewed from a center 10c of the first display device 10. When a virtual object (the third display object D20) exists in the overlaying region 15r, the virtual object is taken as a movable display object Dm20. For example, it is desirable for the virtual object not to interfere with the screen frame when the image of the virtual object moves between the first display device 10 and the second display device 20. As recited above, in the case where the virtual object exists in the overlaying region 15r, it is favorable to implement the processing (e.g., the fourth operation S140) to move the virtual object.

As illustrated in FIG. 11, there are cases where the region 15r where the display region 11r of the first display unit 11 and the display region 21r of the second display unit 21 overlay each other is small as viewed by the human viewer 80. Also, there are cases where the display region 11r and the display region 21r do not overlay each other. There are cases where the virtual object contacts the screen frame. Even in such cases, the image may be displayed in the first display unit 11 when the predicted position of the virtual object enters the first viewed volume 10v of the first display unit 11 without contacting the screen frame. In such a case, a non-display region 16 of the object may be provided. The third display object D20 and the fourth display object D25 are not displayed in the non-display region 16.

In step S350 illustrated in FIG. 9, the image is displayed as-is by the second display device 20 in the case where the movement condition does not satisfy the predetermined condition (step S321).

In the case where the movement condition of the image of the virtual object satisfies the predetermined condition, the first display unit 11 displays the fourth display object D25 (step S360). Then, for example, the third display object D20 is erased; or the second image 21d in which the contrast of the third display object D20 is reduced is displayed by the second display unit 21.

By such an operation, the third operation S130 and the fourth operation S140 are implemented. The operations of the first operation S110 and the second operation S120 can be implemented by interchanging the operation relating to the first display unit 11 and the operation relating to the second display unit 21 in steps S310 to S360.

The fourth display object D25 (or the second display object D15) of step S341 recited above may be generated by a computer in the cloud that is connected to the data output unit 30. In such a case, the information relating to the relative position and the relative angle between the first display device 10 and the second display device 20 detected by the first sensor 50 is supplied to the computer in the cloud via a network; and the data relating to the fourth display object D25 (or the second display object D15) is generated by the computer in the cloud based on the information. This data is supplied to the data output unit 30.

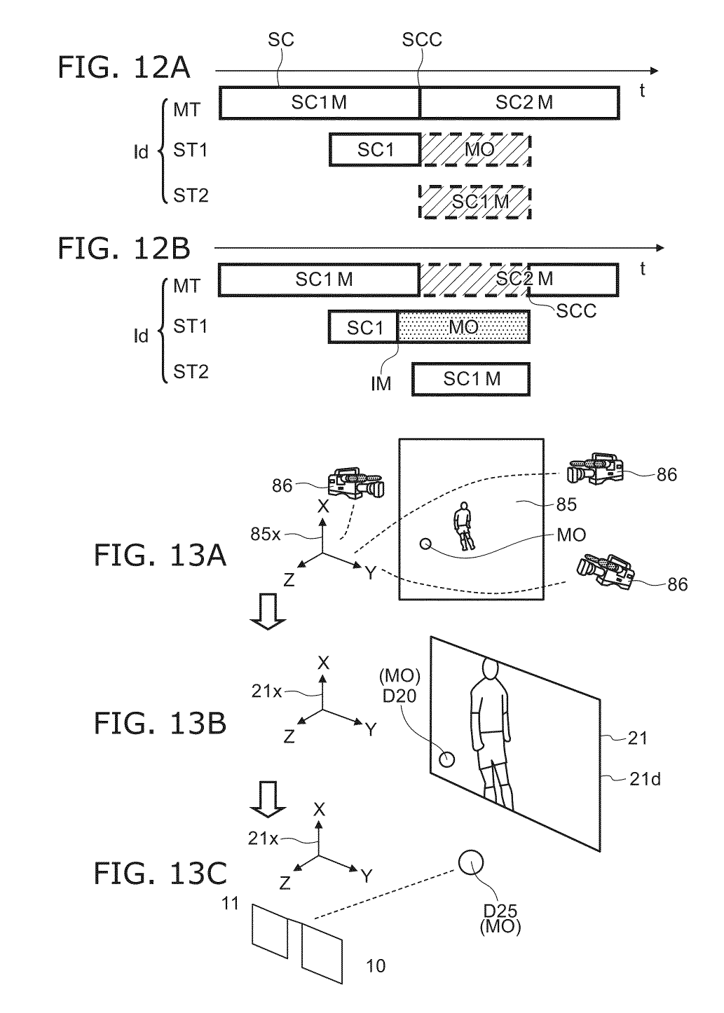

FIG. 12A and FIG. 12B are schematic views illustrating operations of the image display apparatus according to the first embodiment.

As illustrated in FIG. 12A and FIG. 12B, the Image data IDImage data ID used in the image display apparatus 110 according to the embodiment includes, for example, a main track MT and multiple sub-tracks (e.g., a first sub-track ST1, a second sub-track ST2, etc.). For example, the main track MT includes a first scene main SC1M, a second scene main SC2M, etc. For example, the first sub-track ST1 includes a moving object MO of a first scene SC1. For example, the second sub-track ST2 includes the first scene main SC1M. A scene change SCC is performed at a designated time t. After the scene change SCC, the second scene main SC2M of the main track MT, the moving object MO of the first sub-track ST1, and the first scene main SC1M of the second sub-track ST2 are started. Thus, the Image data IDImage data ID includes the image region (the moving object MO) of the virtual object that is movable between the first image 11d and the second image 21d.

FIG. 12A is an example of the case where the Image data IDImage data ID is displayed by the second display device 20 without using the first display device 10. For example, in an actual video image, etc., the scene is changed before the main target goes out of the frame of the display. When the Image data IDImage data ID is displayed by the second display device 20, the first scene main SC1M of the main track MT and the first scene SC1 of the first sub-track ST1 are displayed prior to the scene change SCC. Then, after the scene change SCC, the second scene main SC2M is displayed; and the moving object MO of the first sub-track ST1 and the first scene main SC1M of the second sub-track ST2 are not displayed.

FIG. 12B illustrates an example in which the Image data IDImage data ID is displayed by the first display device 10 and the second display device 20. FIG. 12B is an example in which the moving object MO moves from the second image 21d of the second display device 20 into the first image 11d of the first display device 10. In such a case, in the initial stage, the first scene main SC1M of the main track MT and the first scene SC1 of the first sub-track ST1 are displayed by the second display device 20. Then, when a movement IM of the image starts, the display of the moving object MO of the first sub-track ST1 is performed by the first display device 10. At this time, in the second display device 20, the second scene main SC2M of the main track MT is not displayed; and the first scene main SC1M of the second sub-track ST2 is displayed. Subsequently, when the display of the moving object MO ends, the scene change SCC is performed. After the scene change SCC, for example, the second scene main SC2M is displayed by the second display device 20. Thus, in the case where the image is moved, for example, the seamless movement of the image can be implemented by the first scene being displayed for a constant interval by the second display device 20 and by the moving object MO of the first scene being displayed by the first display device 10. Thereby, a display having less incongruity can be performed.

The moving object MO (the fourth display object D25) displayed by the first display device 10 is generated according to the position and the angle of the first display device 10. To this end, for example, a sub-track including data relating to multi-view images is provided in the Image data IDImage data ID supplied to the data output unit 30. For example, the data used in this sub-track is generated by creating an image corresponding to the position of the first display device 10 (corresponding to the viewpoint of the human viewer 80). Or, a data set of images may be provided beforehand to a computer in the cloud; information such as the position, the angle, the angle of view, etc., of the first display device 10 may be supplied from the data output unit 30 to the computer in the cloud; and the data relating to the moving object MO may be generated by the computer in the cloud. This data is acquired by the data output unit 30; and the image is displayed by the first display device 10 based on this data. An encoding scheme such as MVC (Multi View Codec) may be used to transmit the Image data ID. In the embodiment, the method for generating the image (e.g., at least one selected from the fourth display object D25 and the second display object D15) is arbitrary.

In the embodiment, a designated object (the moving object MO) of a designated scene is perceived to move between the second display device 20 and the first display device 10. Thereby, for example, a more powerful dramatic effect can be provided.

FIG. 13A to FIG. 13C are schematic views illustrating an operation of the image display apparatus according to the first embodiment.

These drawings illustrate an example of a method for generating the Image data ID.

As illustrated in FIG. 13A, for example, an imaging space coordinate system 85x of the X-axis direction, the Y-axis direction, and the Z-axis direction is set in an imaging space 85. The Y-axis direction is perpendicular to the X-axis direction. The Z-axis direction is perpendicular to the X-axis direction and the Y-axis direction. In the imaging space 85, the image that is the target is imaged using multiple imaging devices 86. Information is acquired relating to the position and the angle (the orientation) of each of the multiple imaging devices 86. The information relating to the position and the angle (the orientation) is correlated with the imaging space coordinate system 85x. The position of the moving object MO in the imaging space coordinate system 85x is determined from the information relating to the position and the angle (the orientation).

As illustrated in FIG. 13B, a second image coordinate system 21x is set in the second image 21d. The second image coordinate system 21x is correlated with the imaging space coordinate system 85x. For example, a projective transformation of the imaging space coordinate system 85x into the second image coordinate system 21x of the second display device 20 is performed. Thereby, the relationship between the imaging space coordinate system 85x and the second image coordinate system 21x is determined.

As illustrated in FIG. 13C, the relative position and the relative angle (the orientation) of the first display device 10 are expressed using the second image coordinate system 21x.

The position of the moving object MO when viewed via the first display device 10 (the first display unit 11) is determined from the position of the moving object MO of the imaging space coordinate system 85x, the relationship between the imaging space coordinate system 85x and the second image coordinate system 21x, and the relative position and the relative angle (the orientation) of the first display device 10 expressed using the second image coordinate system 21x recited above. By using the position of the moving object MO that is determined, projective transformation of the moving object MO (e.g., the fourth display object D25) into the first image 11d is performed.

Thus, an image corresponding to the position of the first display device 10 is generated from the images of several viewpoints in the sub-track. At this time, the moving object MO (e.g., the fourth display object D25) displayed by the first display device 10 is synchronous with the second image 21d of the second display device 20. For example, the first image 11d is pre-generated after acquiring the information relating to the relative position and the relative angle of the first display device 10 (e.g., step S341). Then, the images corresponding to the first display unit 11 and the second display unit 21 are displayed respectively by the first display unit 11 and the second display unit 21 (e.g., step S360) when the condition of the movement of the image relating to the moving object MO is satisfied (e.g., step S350).

For example, the method for transforming the coordinates recited above is applicable to the processing of the second display object D15 being displayed by the second display unit 21 by interchanging the relationship between the first display device 10 and the second display device 20.

For example, the operation recited above is applicable in the case where the image (the content) that is displayed is a two-dimensional video image. However, the embodiment is not limited thereto. An operation similar to that recited above is implemented also in the case where the content that is displayed is a three-dimensional video image. In the case where the content including the three-dimensional information is displayed, the coordinate values corresponding to the imaging space 85 when acquiring the Image data ID are known. Therefore, the projective transformation of the moving object MO can be easily implemented. Therefore, the generation of the fourth display object D25 and the second display object D15 is easy.

In the embodiment, the fourth operation S140 is implemented when the predicted position of the virtual object (the third display object D20) enters the first viewed volume 10v of the first display unit 11. In the fourth operation S140 at this time, the fourth display object D25 is displayed in the first image 11d at a position on an extension of the movement of the third display object D20 as viewed by the human viewer 80.

The second operation S120 is implemented when the predicted position of the virtual object (the first display object D10) enters the second viewed volume 20v of the second display unit 21. In the second operation S120 at this time, the second display object D15 is displayed in the second image 21d at a position on an extension of the movement of the first display object D10 as viewed by the human viewer 80.

For example, in the fourth operation S140, the temporal change of the fourth display object D25 (e.g., the temporal change of the color, the configuration, the size, etc.) is continuous with the temporal change of the third display object D20. For example, in the second operation S120, the temporal change of the second display object D15 (e.g., the temporal change of the color, the configuration, the size, etc.) is continuous with the temporal change of the first display object D10.

In other words, in the second output operation S2, the data output unit 30 outputs the first data 10d of the fourth operation S140 such that the fourth display object D25 of the fourth operation S140 is continuous with the change of the third display object D20 in the second image 21d of the third operation S130. For example, the change of the third display object D20 in the second image 21d of the third operation S130 is the temporal change of the third display object D20.

Similarly, in the first output operation S1, the data output unit 30 outputs the second data 20d of the second operation S120 such that the second display object D15 of the second operation S120 is continuous with the change of the first display object D10 in the first image 11d of the first operation S110. For example, the change of the first display object D10 in the first image 11d of the first operation S110 is the temporal change of the first display object D10.

Thereby, the incongruity of the color, the configuration, the size, the position, and the movement direction of the virtual object when the virtual object moves between the first display device 10 and the second display device 20 can be suppressed.

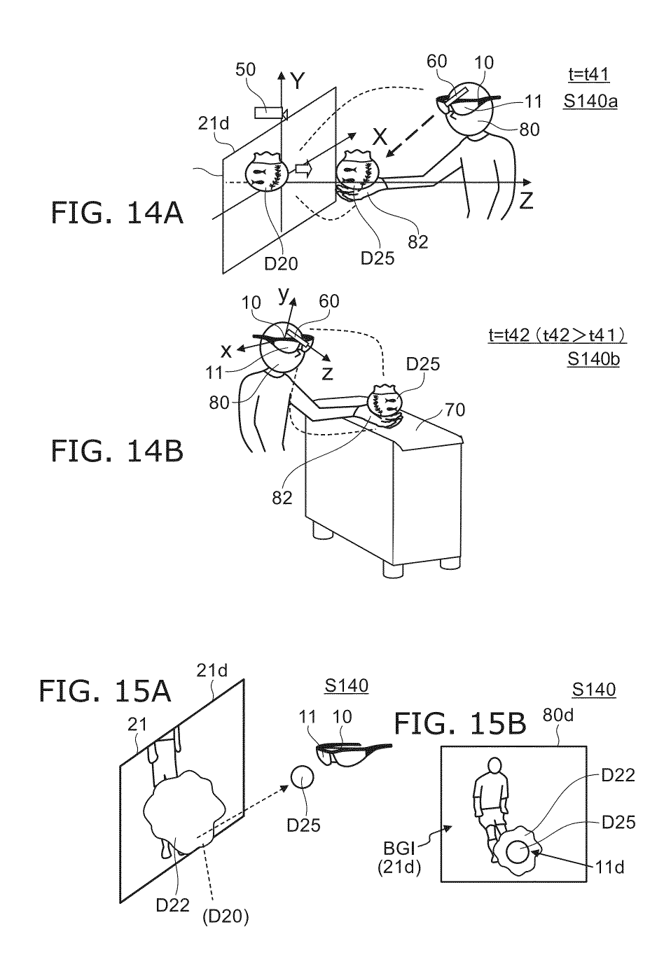

FIG. 14A and FIG. 14B are schematic views illustrating an operation of the image display apparatus according to the first embodiment.

These drawings illustrate the fourth display object display operation S140a and the placement operation S140b of the fourth operation S140.

FIG. 14A illustrates the state in which the time t is a first time t41. FIG. 14B illustrates the state in which the time t is a second time t42. The second time t42 is a time after the first time t41.

For example, in the state in which the third display object D20 (e.g., an image of merchandise) is displayed in the second image 21d of the second display unit 21 as illustrated in FIG. 14A (the third operation S130), the fourth display object D25 based on the third display object D20 is displayed by the first display unit 11 (the fourth display object display operation S140a of the fourth operation S140) based on an operation by the human viewer 80. For example, the virtual object displayed by the second display unit 21 is moved from the second display unit 21 onto the hand of the user. At this time, the data relating to the fourth display object D25 may be stored.

Subsequently, as illustrated in FIG. 14B, the fourth display object D25 is displayed based on the data relating to the fourth display object D25 (the placement operation S140b). The fourth display object D25 is disposed in the first image 11d such that the fourth display object D25 is disposed on the desk (the object 70) as viewed by the human viewer 80. For example, the state illustrated in FIG. 14A may transition to the state of FIG. 14B by continuously displaying the fourth display object D25.

In the fourth display object display operation S140a illustrated in FIG. 14A, the virtual object (the fourth display object D25) moves toward the hand (the body 82) of the user (the human viewer 80). In the fourth display object display operation S140a, the position of the fourth display object D25 in the first image 11d may be established based on the position of the object image D70 of the body 82 of the human viewer 80. In other words, the fourth display object display operation S140a and the placement operation S140b may be implemented simultaneously. Thereby, the virtual object is perceived to move without incongruity from the second display unit 21 onto the hand of the user.

For example, the position of the hand (the body 82) of the user in three-dimensional space is detected by the first sensor 50. Or, a second sensor 60 may be provided separately from the first sensor 50; and the position of the hand (the body 82) of the user in three-dimensional space may be detected by the second sensor 60.

In other words, the image display apparatus 110 may further include the second sensor 60. The second sensor 60 detects the object image D70 that exists in the region around the first display device 10. For example, the object image D70 includes the image of at least a portion of the body 82 of the human viewer 80. For example, the object image D70 includes the image of the object 70 (e.g., a desk, etc.) existing in the region around the first display device 10 (around the human viewer 80).

The data output unit 30 may implement the placement operation S140b in the operation (the fourth operation S140) in which the fourth display object D25 is displayed by the first display unit 11. In the placement operation S140b, the data output unit 30 outputs the first data 10d including the information of the first image 11d to display the fourth display object D25 in the first image 11d using a reference, where the reference is the position of the object image D70 when the human viewer 80 views the object image D70 detected by the second sensor 60 via the first display unit 11.

For example, the second sensor 60 is additionally provided in the first display device 10. For example, the second sensor 60 is mounted on the first display device 10. The second sensor 60 may include, for example, an imaging device. Thereby, the position of the object image D70 (e.g., the hand, etc.) in space is determined; and the movement path of the virtual object is determined. For example, an XYZ coordinate system is established using the second display unit 21 as a reference; and the position of the hand is established using this coordinate system. For example, the fourth display object D25 can be disposed at the desired position (e.g., the position of the hand) using the information of the position of the hand by performing processing similar to the case where the content of the image has three-dimensional information.

As illustrated in FIG. 14B, the human viewer 80 causes the fourth display object D25 to be displayed by the first display unit 11 based on the data that is stored (the placement operation S140b). In other words, the image of the virtual object displayed by the first display unit 11 is interactively disposed at the prescribed position in real space. Thus, when disposing the fourth display object D25 at the prescribed position in real space, the virtual object moves with the user. Therefore, the position of the virtual object and the position of the destination are expressed using a coordinate system that moves with the user. In this example, the position and the orientation of the real object at the destination are detected by the second sensor 60. By using the second sensor 60, the positions and the orientations of the hand of the user and the real object in real space as viewed by the user can be detected.

For example, when the position of the user can be detected by the first sensor 50 as illustrated in FIG. 14A, the second display device 20, the first display device 10 (the user), and the virtual object (the fourth display object D25) may be expressed using the same coordinate system based on the detection result of the first sensor 50.

For example, in the state in which the first display device 10 (the user) cannot be detected by the first sensor 50 as illustrated in FIG. 14B, the virtual object is expressed using a coordinate system that uses the position of the user as a reference by using the second sensor 60 that is additionally provided in the first display device 10.

In the image display apparatus 110 according to the embodiment, the movement of the virtual object between the first display unit 11 and the second display unit 21 is performed by the first output operation S1 and the second output operation S2. The operation recited above is implemented such that this movement is naturally perceived. For example, the movement of the virtual object is perceived unnaturally due to the error and the time delay (the detection error) of the relative position and the relative angle between the first display device 10 and the second display device 20, the difference of the display parameters (the parameter difference) between the first display device 10 and the second display device 20, the difficulty of viewing (the visual noise) due to the background image transmitted by the first display unit 11, etc.

For example, the detection error recited above increases in the case where, for example, the movement of the head of the user (the human viewer 80) is severe. For example, the detection error increases in the case where the change of the relative position and the relative angle between the first display device 10 and the second display device 20 is large.

For example, the data output unit 30 implements at least one selected from the first output operation S1 and the second output operation S2 when the change amount of the relative position detected by the first sensor 50 is not more than a predetermined value and when the change amount of the relative angle detected by the first sensor 50 is not more than a predetermined value. The data output unit 30 does not implement the first output operation S1 and the second output operation S2 in the case where the change amount of the relative position exceeds the predetermined value or in the case where the change amount of the relative angle exceeds the predetermined value. For example, the change amount of the relative position is the change amount of the relative position within a predetermined amount of time. For example, the change amount of the relative angle is the change amount of the relative angle within a predetermined amount of time.

For example, the movement of the virtual object is implemented when the change amount of the relative position and orientation between the first display device 10 and the second display device 20 determined from the detection result of the first sensor 50 is not more than the prescribed value and is not implemented in the case where the prescribed value is exceeded.

By such an operation, the unnaturalness caused by the detection error can be suppressed.

Also, by providing a sensation of movement when moving the virtual object, the incongruity during the movement is suppressed; and the unnaturalness also can be suppressed. For example, the sound producing unit 40 is provided in the image display apparatus 110. A sound is produced by the sound producing unit 40 in at least one operation selected from the first output operation S1 and the second output operation S2 by the data output unit 30. A sound effect is produced by the sound producing unit 40 when moving the virtual object. Thereby, for example, the unnaturalness caused by the detection error can be suppressed.

In the fourth operation S140, the spatial frequency of the image in the second image 21d may be reduced. Thereby, for example, a smoke-like image effect is provided by the second display unit 21.

FIG. 15A and FIG. 15B are schematic views illustrating another operation of the image display apparatus according to the first embodiment.

These drawings illustrate an example of the fourth operation S140.

FIG. 15A illustrates the relationship between the dispositions of the first display unit 11 (the human viewer 80) and the second display unit 21. FIG. 15B illustrates the viewed image 80d (the first image 11d and the background image BGI) that is viewed by the human viewer 80 via the first display unit 11.

As illustrated in FIG. 15A and FIG. 15B, a low spatial frequency noise image D22 is added to the second image 21d as texture in the fourth operation S140. For example, the low spatial frequency noise image D22 is displayed in the second image 21d at a position overlaying the third display object D20 or at a position in the region around the third display object D20. Thereby, the incongruity when moving the virtual object is suppressed.

Such a low spatial frequency noise image D22 may be provided in the second operation S120. Thereby, for example, the unnaturalness caused by the detection error can be suppressed.

There are cases where the difference (the parameter difference) between the display parameters of the first display device 10 and the second display device 20 is large. For example, the display parameters include the color, the luminance, the resolution, the vertical:horizontal ratio of the screen, the viewing distance, etc. For example, there are cases where the color, the luminance, the resolution, the vertical:horizontal ratio of the screen, and the viewing distance are greatly different between the first display device 10 and the second display device 20.

For example, the transformation formula for the color, the luminance, the dimensions, etc., is pre-made; and the transformation formula is used when moving the virtual object. Thereby, the incongruity can be suppressed.

For example, the RGB values of the color of the second display device 20 are taken as (r0, g0, and b0); and the RGB values of the color of the first display device 10 are taken as (r1, g1, and b1). In the case where the characteristics relating to the color are linear, (r0, g0, and b0) can be expressed using the transformation of Formula 1.

$$( \begin{matrix}r 1 \\ g 1 \\ b 1\end{matrix} ) = ( \begin{matrix}a 00 & a 01 & a 02 \\ a 10 & a 11 & a 12 \\ a 20 & a 21 & a 22\end{matrix} ) ( \begin{matrix}r 0 \\ g 0 \\ b 0\end{matrix} ) \qquad ( 1 )$$

By using this transformation formula, the color per pixel is determined.

For example, in the first output operation S1, the data output unit 30 can establish the color and the luminance of the second display object D15 of the output of the second data 20d of the second operation S120 by transforming the color and the luminance of the first display object D10 of the first operation S110 by a predetermined method.

Also, in the second output operation S2, the data output unit 30 can establish the color and the luminance of the fourth display object D25 of the output of the first data 10d of the fourth operation S140 by transforming the color and the luminance of the third display object D20 of the third operation S130 by a predetermined method.

Thereby, the unnaturalness caused by the parameter difference can be suppressed.

For example, when the image of the virtual object is displayed by the first display unit 11, the background image is perceived as being transparent when an image having a high luminance is displayed in the second image 21d of the second display unit 21 of the background of the first display unit 11. Thereby, visual noise occurs; and there are cases where the reality decreases even when the image of the virtual object jumps out.

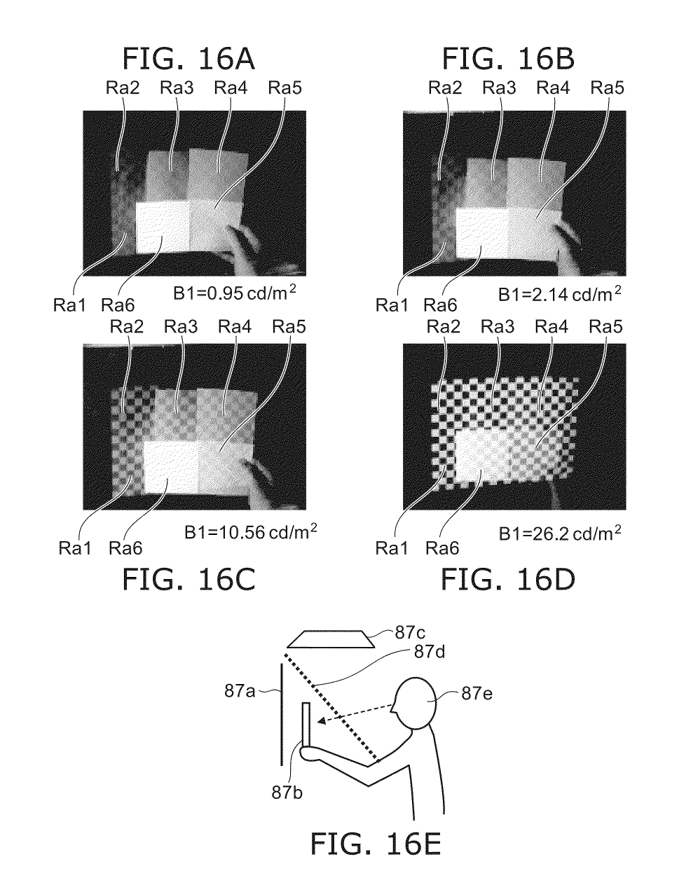

FIG. 16A to FIG. 16E are schematic views illustrating an experiment relating to the characteristics of the image display apparatus.

FIG. 16E is a schematic view illustrating the experimental conditions. FIG. 16A to FIG. 16D are photographs illustrating the experimental results.

As illustrated in FIG. 16E, a half mirror 87d is disposed in front of a participant 87e. The light emitted from a display 87c is incident on the half mirror 87d. The light that is incident on the half mirror 87d is incident on the participant 87e. An image is formed of the light emitted from the display 87c at a prescribed position. In this example, a checkered pattern is displayed by the display 87c. Thereby, a checkered image 87a is formed in front of the participant 87e. For example, the checkered image 87a corresponds to the first image 11d of the first display unit 11. A sample real object 87b is disposed between the checkered image 87a and the participant 87e. For example, the sample real object 87b corresponds to the second image 21d of the second display unit 21. In this experiment, the sample real object 87b includes six regions (a first region Ra1 to a sixth region Ra6). The luminance of the first region Ra1 to the sixth region Ra6 are 0.4 cd/m², 1.4 cd/m², 2.1 cd/m², 4.7 cd/m², 8.4 cd/m², and 13.5 cd/m², respectively. The appearances of the checkered image 87a and the sample real object 87b are evaluated for luminance of the white portions of the checkered image 87a of 0.95 cd/m², 2.14 cd/m², 10.56 cd/m², and 26.1 cd/m².

FIG. 16A to FIG. 16D are photographs for luminance of white portions of the checkered image 87a of 0.95 cd/m², 2.14 cd/m², 10.56 cd/m², and 26.1 cd/m², respectively.

It can be seen from these figures that the visibility of the image and the background of the light-transmitting display depends on the difference between the luminance of the image and the luminance of the background. When the brightness of the background is higher than the brightness of the image, the image is transparent, and the background is visually confirmed. When the brightness of the background is not more than the brightness of the image, the background is not easily visually confirmed.

The occurrence of the visual noise can be suppressed by reducing the luminance of the first image 11d in the second operation S120 and by reducing the luminance of the second image 21d in the fourth operation S140.

Whether or not the background image is highly noticeable has a relationship with the spatial frequency of the image of the virtual object and the spatial frequency of the background in the case where the background is considered to be an image.

For example, in the fourth operation S140 of the second output operation S2, the luminance difference is increased by implementing at least one selected from increasing the luminance of the first image 11d and decreasing the luminance of the second image 21d. The image is caused to be in an indistinct state by reducing the display spatial frequency of the second image 21d. Thereby, the display of the second image 21d in the fourth operation S140 can be not highly noticeable.

Further, the occurrence of the visual noise can be suppressed by modifying the color of the first image 11d based on the transmittance of the background color of the second image 21d.

For example, in the fourth operation S140, the data output unit 30 can output the second data 20d including the information of the second image 21d for which at least one selected from decreasing the luminance of the second image 21d and decreasing the spatial frequency of at least a portion of the second image 21d with respect to the second image 21d of the third operation S130 is implemented. Thereby, in the fourth operation S140, the occurrence of the visual noise caused by the second image 21d being perceived via the first display unit 11 can be suppressed.

Also, in the second operation S120, the data output unit 30 can output the first data 10d including the information of the first image 11d for which at least one selected from decreasing the luminance of the first image 11d and decreasing the spatial frequency of at least a portion of the first image 11d with respect to the first image 11d of the first operation S110 is implemented. Thereby, in the second operation S120, the occurrence of the visual noise caused by the first image 11d being perceived can be suppressed.

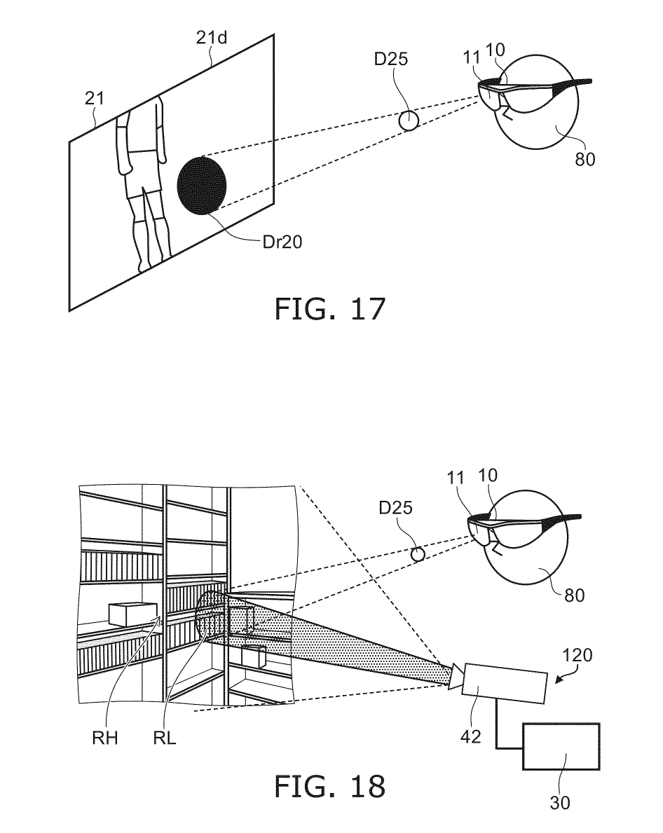

FIG. 17 is a schematic view illustrating another operation of the image display apparatus according to the first embodiment.

As illustrated in FIG. 17, the luminance of a portion of the second image 21d is reduced. A portion Dr20 where the luminance is reduced in the second image 21d is a portion where the fourth display object D25 projected onto the second image 21d as viewed by the human viewer 80. In other words, the luminance of the portion (the portion Dr20) of the virtual object projected onto the second display unit 21 from the viewpoint of the user is caused to be lower than that of the other portions. Thereby, the human viewer 80 can be caused to have less recognition of the second image 21d.

FIG. 18 is a schematic view illustrating the configuration and an operation of the image display apparatus according to the first embodiment.

As illustrated in FIG. 18, the image display apparatus 120 according to the embodiment further includes a projector 42 in addition to the data output unit 30, the first display device 10, and the second display device 20. The projector 42 is connected to the data output unit 30. The projector 42 increases the luminance of a region RH of the background that does not overlay the fourth display object D25 to be higher than the luminance of a region RL of the background that overlays the fourth display object D25 when the background is viewed via the first display unit 11 by the human viewer 80.

In other words, the luminance of the location (the region RL) in real space corresponding to the image of the virtual object is reduced by the projector 42 to be lower than that of the other locations (the region RH). Thereby, the occurrence of the visual noise can be suppressed.

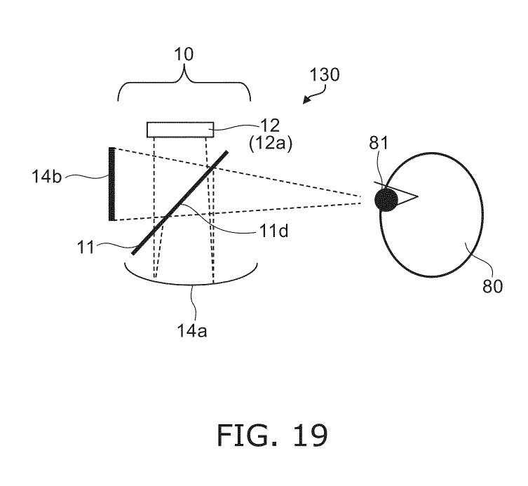

FIG. 19 is a schematic view illustrating another image display apparatus according to the first embodiment.

In the image display apparatus 130 according to the embodiment as illustrated in FIG. 19, the first display device 10 further includes a shielding unit 14b in addition to the first display unit 11 and the image generation unit 12 (the display device 12a). In this example, the first display device 10 further includes a concave mirror 14a.

A semi-transmissive reflection plate (a semi-transmissive reflective layer), i.e., a half mirror, is used as the first display unit 11. The light emitted from the image generation unit 12 is reflected by the concave mirror 14a; and the image is enlarged. The light reflected by the concave mirror 14a is reflected by the first display unit 11 to be incident on the eye 81 of the human viewer 80. The human viewer 80 views the image (the first image 11d) based on the light reflected by the first display unit 11. As viewed by the human viewer 80, a portion of the first image 11d overlays the shielding unit 14b. For example, the shielding unit 14b shields the light from the outside that would be incident on the eye 81 of the human viewer 80 via the first display unit 11. For example, at least a portion of the second image 21d of the second display unit 21 is shielded by the shielding unit 14b. For example, the region that shields includes a region overlaying the fourth display object D25 as viewed by the human viewer 80. Thereby, the occurrence of the visual noise can be suppressed. The optical transmittance of the shielding unit 14b may be changed.

For example, although a light-transmitting HMD may be used as the first display device 10, the embodiment is not limited thereto. For example, a light-transmitting tablet display or a video see-through tablet display may be used as the first display device 10. In such a case as well, a display that moves the virtual object between real space and the virtual space can be provided.

### Second Embodiment

The second embodiment relates to a display method. For example, the display method according to the embodiment includes the processing described in regard to FIG. 3A, FIG. 3B, and FIG. 7.

In this display method, the first data 10d of the first image 11d is supplied to the first display device 10 including the optically-transmissive first display unit 11 that displays the first image 11d; and the second data 20d of the second image 21d is supplied to the second display device 20 including the second display unit 21 that displays the second image 21d. The second image 21d displayed by the second display unit 21 is viewable by the human viewer via the first display unit 11.

In this display method, at least one selected from the first output operation S1 and the second output operation S2 is implemented.

The first output operation S1 includes the first operation S110 and the second operation S120. In the first operation S110, the first data 10d is supplied to display the first display object D10 in the first image 11d. In the second operation S120 after the first operation S110, the second data 20d is supplied to display the display object (the second display object D15) based on the first display object D10 in the second image 21d at a position overlaying the first display object D10 as viewed by the human viewer 80 or at a position on an extension of the movement of the first display object D10 as viewed by the human viewer 80.

The second output operation S2 includes the third operation S130 and the fourth operation S140. In the third operation S130, the second data 20d is supplied to display the third display object D20 in the second image 21d. In the fourth operation S140 after the third operation S130, the first data 10d is supplied to display the display object (the fourth display object D25) in the first image 11d based on the third display object D20 at a position overlaying the third display object D20 as viewed by the human viewer 80 or at a position on an extension of the movement of the third display object D20 as viewed by the human viewer 80.

According to the embodiment, a display method that provides an image having a strong sense of presence and better harmony between real space and the virtual object can be provided.

In the embodiment, the first display device 10 including the light-transmitting first display unit 11, the second display device 20 including the second display unit 21, the data output unit 30, and a position and orientation sensor (the first sensor 50) are provided. The first sensor 50 detects the relative position and the relative angle between the first display device 10 and the second display device 20. The data output unit 30 supplies the image data. The images of the second display unit 21 and the first display unit 11 are generated such that the image of the virtual object displayed by one selected from the second display unit 21 and the first display unit 11 is moved into the image of the other display unit based on the movement of the virtual object or the operation by the user.

In the embodiment, a real space sensor (the second sensor 60) may be further provided to ascertain the position/orientation of the hand or leg of the user and the position/orientation of a real object in the region around the user. The display of the first display device 10 is controlled based on the operation by the user or the circumstances of the virtual object such that the virtual object displayed by the first display device 10 exists at a prescribed position in real space.

The image movement is implemented in the case where the change amounts of the relative position and the relative angle (the orientation) between the first display device 10 and the second display device 20 that are determined by the position and orientation sensor is not more than a prescribed value.

The method for transforming the color information is pre-specified such that the display color and the luminance are substantially the same for the eye that views the virtual object that moves. The image switching control is performed such that there are no inconsistencies in the size, the position in real space, and the movement direction for the virtual object that moves between the first display device 10 and the second display device 20.

According to the embodiment, an image display apparatus having a strong sense of presence and better harmony between real space and the virtual object is provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in image display apparatuses such as first display devices, first display units, second display devices, second display units, data output units, first sensors, second sensors, etc., from known art; and such practice is included in the scope of the invention to the extent that similar effects are obtained.

Further, any two or more components of the specific examples may be combined within the extent of technical feasibility and are included in the scope of the invention to the extent that the purport of the invention is included.

Moreover, all image display apparatus practicable by an appropriate design modification by one skilled in the art based on the image display apparatuses described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image display apparatus, comprising:
a data output unit configured to output first data and second data, the first data including information of a first image, the second data including information of a second image;
a first display device including a first display unit configured to display the first image based on the first data, the first display unit being optically transmissive; and
a second display device including a second display unit configured to display the second image based on the second data, the second image displayed by the second display unit being viewable by a human viewer via the first display unit,
the data output unit being configured to implement at least one selected from:
a first output operation including
a first operation configured to output the first data including the information of the first image including a first display object, and
a second operation configured to output the second data including the information of the second image including a second display object after the first operation based on the first display object, a position of the second display object in the second image being a position overlaying the first display object as viewed by the human viewer or a position on an extension of a movement of the first display object as viewed by the human viewer; and
a second output operation including
a third operation configured to output the second data including the information of the second image including a third display object, and
a fourth operation configured to output the first data including the information of the first image including a fourth display object after the third operation based on the third display object, a position of the fourth display object in the first image being a position overlaying the third display object as viewed by the human viewer or a position on an extension of a movement of the third display object as viewed by the human viewer.

2. The apparatus according to claim 1, wherein
the data output unit further implements outputting the first data including the information of the first image not including the first display object in the second operation, and
the data output unit further implements outputting the second data including the information of the second image not including the third display object in the fourth operation.

3. The apparatus according to claim 1, wherein
the data output unit further implements outputting the first data including the information of the first image with a ratio of a luminance of the first display object to a luminance around the first display object in the first image of the second operation being lower than a ratio of the luminance of the first display object to the luminance around the first display object of the first operation, and
the data output unit further implements outputting the second data including the information of the second image with a ratio of a luminance of the third display object to a luminance around the third display object in the second image of the fourth operation being lower than a ratio of the luminance of the third display object to the luminance around the third display object of the third operation.

4. The apparatus according to claim 1, wherein
the data output unit outputs the first data in the second operation to include the information of the first image including at least one selected from decreasing a luminance of the first image with respect to the first image of the first operation and decreasing a spatial frequency of at least a portion of an image in the first image with respect to the first image of the first operation, and
the data output unit outputs the second data in the fourth operation to include the information of the second image including at least one selected from decreasing a luminance of the second image with respect to the second image of the third operation and decreasing a spatial frequency of at least a portion of an image in the second image with respect to the second image of the third operation.

5. The apparatus according to claim 1, further comprising a first sensor configured to detect a relative position and a relative angle between the first display device and the second display device,
the data output unit implementing the second operation and the fourth operation based on the relative position and the relative angle detected by the first sensor.

6. The apparatus according to claim 5, wherein the data output unit implements the at least one selected from the first output operation and the second output operation when a change amount of the relative position detected by the first sensor is not more than a predetermined value and a change amount of the relative angle detected by the first sensor is not more than a predetermined value.

7. The apparatus according to claim 1, wherein the data output unit implements at least one selected from the second operation and the fourth operation based on an operation by the human viewer.

8. The apparatus according to claim 1, wherein
the data output unit implements the fourth operation when a movement of the third display object in the second image of the third operation meets a predetermined condition.

9. The apparatus according to claim 8, wherein the predetermined condition includes at least one of a state in which a size of the third display object increases over time and a state in which a size of the third display object changes continuously over time.

10. The apparatus according to claim 1, wherein
the data output unit implements the second operation when a movement of the first display object in the first image of the first operation meets a predetermined condition.

11. The apparatus according to claim 10, wherein the predetermined condition includes a state in which a change of the first display object exceeds a predetermined threshold value.

12. The apparatus according to claim 1, further comprising a second sensor configured to detect an object image existing in a region around the first display device,
the data output unit outputting the first data including the information of the first image to display the fourth display object in the first image using a reference in the fourth operation, the reference being a position of the object image when the human viewer views the object image detected by the second sensor via the first display unit.

13. The apparatus according to claim 12, wherein the second sensor is mounted on the first display device.

14. The apparatus according to claim 1, further comprising a second sensor configured to detect an object image existing in a region around the first display device,
the data output unit outputting the first data including the information of the first image to display the first display object in the first image using a reference in the first operation, the reference being a position of the object image when the human viewer views the object image detected by the second sensor via the first display unit.

15. The apparatus according to claim 1, wherein
the data output unit outputs the second data in the second operation of the first output operation, the second display object of the second operation being continuous with a change of the first display object in the first image of the first operation, and
the data output unit outputs the first data in the fourth operation of the second output operation, the fourth display object of the fourth operation being continuous with a change of the third display object in the second image of the third operation.

16. The apparatus according to claim 1, wherein
the data output unit establishes a color and a luminance of the second display object in the second operation of the first output operation by transforming a color and a luminance of the first display object of the first operation by a predetermined method, and
the data output unit establishes a color and a luminance of the fourth display object in the fourth operation of the second output operation by transforming a color and a luminance of the third display object of the third operation by a predetermined method.

17. The apparatus according to claim 1, further comprising a sound producing unit configured to produce sound in the at least one operation selected from the first output operation and the second output operation of the data output unit.

18. The apparatus according to claim 1, wherein the first display device is a Head Mounted Display that is wearable by the human viewer.

19. The apparatus according to claim 1, wherein the first display device is linked to a movement of a head of the human viewer.

20. The apparatus according to claim 1, wherein the first display device includes a semi-transmissive reflective layer.
